(19) United States
(12) Patent Application Publication
(10) Pub. No.: US 2023/0161174 A1
(43) Pub. Date: May 25, 2023

(54) FLOATING-IMAGE DISPLAY DEVICE AND FLOATING-IMAGE DISPLAY METHOD

(71) Applicant: Nippon Telegraph and Telephone Corporation, Tokyo (JP)

(72) Inventors: Motohiro MAKIGUCHI, Musashino-shi, Tokyo (JP); Hideaki TAKADA, Musashino-shi, Tokyo (JP); Takashi SATO, Musashino-shi, Tokyo (JP)

(21) Appl. No.: 17/920,186

(22) PCT Filed: Apr. 21, 2020
(86) PCT No.: PCT/JP2020/017232

§ 371 Date: Oct. 20, 2022

(51) Int. Cl. G02B 30/56; G02B 17/00; G02B 30/10

(52) U.S. Cl. CPC G02B 30/56; G02B 17/006; G02B 30/10

(57) ABSTRACT

A floating image display apparatus of the present embodiment includes: a first display unit (11) that is installed to have a display surface facing toward a ground; a first optical element (21) that is installed to be inclined with respect to the ground, and transmits a part of light emitted from the first display unit (11) and reflects a part of the light; a second display unit (12) that is installed to have a display surface perpendicular to the ground; and a second optical element (22) that is installed to be perpendicular to the ground, and transmits a part of light emitted from the second display unit (12) and reflects a part of the light.

### TECHNICAL FIELD

The present invention relates to a floating image display apparatus and a floating image display method.

### BACKGROUND ART

A known floating image projection apparatus projects a virtual image of a subject displayed on a display apparatus as a floating image onto a space. NPL 1 discloses a technology in which a plurality of half mirrors are installed in a depth direction and floating images are projected in multiple layers.

### CITATION LIST

### Non Patent Literature

NPL 1: Motohiro MAKIGUCHI, Arinobu NIIJIMA, Hideaki TAKADA, Tatsuya MATSUI, Yasuyuki YABUMOTO, Masanori YOKOYAMA, “Proposal of Compact Multilayer Floating-Image Projection System Using Smartphone”, IPSJ Interaction 2016, Information Processing Society of Japan, 24 Feb. 2016, pp. 150-157

### SUMMARY OF THE INVENTION

### Technical Problem

A case is considered where a technology of projecting the floating image in multiple layers by installing a plurality of the half mirrors is applied to sports watching. For example, the above technology is applied to watching a badminton game, and on a badminton court, each of a player on a front side of the court and a player on a deeper side of the court is displayed in separate floating images. Accordingly, this makes it possible to realize an experience of being given feeling of watching the badminton game performed on the court.

However, the half mirror that projects the floating image on the deeper side needs to be installed on a stage (court), and thus, the arrangement of a real object and the performer on the stage, and a stage production such as lighting are restricted.

The present invention has been made in view of the above issue, and an object of the present invention is to provide a multilayer floating image display apparatus that does not interfere with the production on the stage.

### Means for Solving the Problem

According to an aspect of the present invention, a floating image display apparatus includes: a first display unit configured to be installed to have a display surface facing toward a ground; a first optical element configured to be installed to be inclined with respect to the ground, and configured to transmit a part of light emitted from the first display unit and reflect a part of the light; a second display unit configured to be installed to have a display surface perpendicular to the ground; and a second optical element configured to be installed to be perpendicular to the ground, and configured to transmit a part of light emitted from the second display unit and reflect a part of the light.

According to another aspect of the present invention, a floating image display method includes: displaying a first image by a first display unit installed to have a display surface facing toward a ground; emitting light of the first image to a first optical element that is installed to be inclined with respect to the ground, transmits a part of incident light, and reflects a part of the incident light; displaying a second image by a second display unit installed to have a display surface perpendicular to the ground; and emitting light of the second image to a second optical element that is installed to be perpendicular to the ground, transmits a part of incident light, and reflects a part of the incident light.

### Effects of the Invention

According to the present invention, the multilayer floating image display apparatus that does not interfere with the production on the stage can be provided.

### BRIEF DESCRIPTION OF DRAWINGS

FIG. 1 is a diagram illustrating a schematic configuration example of a floating image display apparatus according to a present embodiment.

FIG. 2 is a diagram illustrating a schematic configuration example of a floating image display apparatus according to a comparative example.

### DESCRIPTION OF EMBODIMENTS

Floating Image Display Apparatus of Present Embodiment

Hereinafter, a floating image display apparatus of the present embodiment will be described with reference to the drawings.

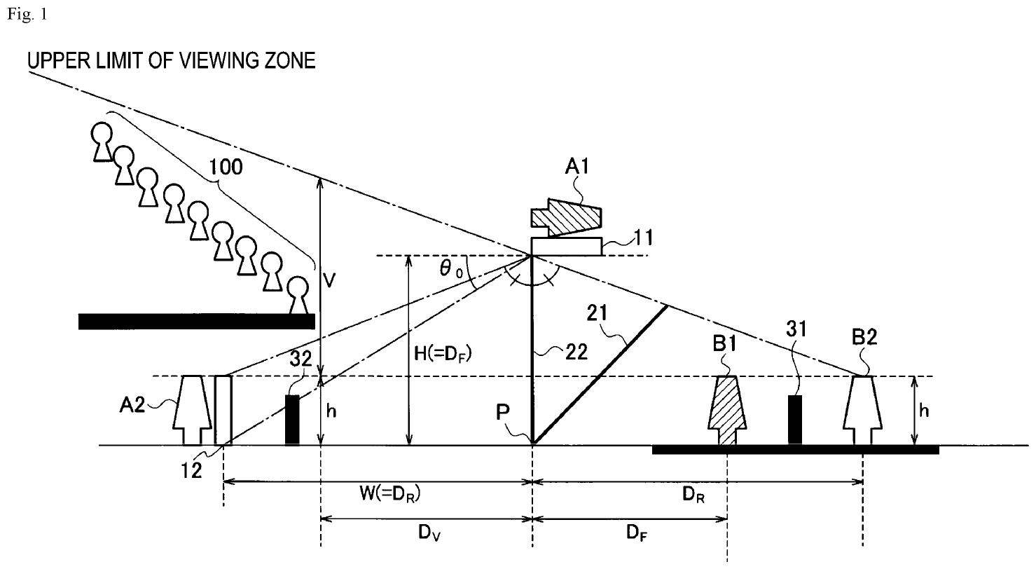

The floating image display apparatus of the present embodiment will be described with reference to FIG. 1. The floating image display apparatus illustrated in the drawing is a display apparatus that projects the floating image in multiple layers on a front side and a deeper side of a stage 30 as viewed from a spectator 100. The stage 30 is, for example, an actual court of an indoor badminton competition venue, and a length of a line of the court in a left and right direction in the drawing is 13.4 m. An actual net 31 is installed in a center of the stage 30. The spectator 100 recognizes, as a floating image, a virtual image B1 on the court on a front side of the net 31 and a virtual image B2 on the court on a back side of the net 31, which are projected by the floating image display apparatus. By projecting an image capturing the player of the badminton game performed in the other venue as a floating image on the actual court, the spectator 100 can watch the badminton game.

The floating image display apparatus illustrated in FIG. 1 includes a first display unit 11, a second display unit 12, a first optical element 21, and a second optical element 22.

The first display unit 11 is disposed at a position with a height H from a ground (the same plane as an upper surface of the stage 30) between a spectator's seat and the stage 30, such that a display surface of the first display unit 11 is parallel with the ground and faces downward (toward the first optical element 21). As the first display unit 11, for example, a display apparatus such as an LED display and an organic EL display can be used. A display image A1 is displayed on the display surface of the first display unit 11. The display image A1 is, for example, an image of the player on the court on the front side of the net 31.

The first optical element 21 is installed to be inclined with respect to the ground at a position below the first display unit 11, and receives light emitted from the first display unit 11. In the example illustrated in FIG. 1, at a position corresponding to a lower end of the first display unit 11, the first optical element 21 is installed such that one side of the first optical element 21 is brought into contact with the ground and inclined at 45 degrees with respect to the ground. A point at which the first optical element 21 is brought into contact with the ground is referred to as a base point P. The first optical element 21 is a rectangular or square plate-like optical element, reflects a part of the incident light and transmits a part of the incident light. For example, a half mirror can be used as the first optical element 21.

The second display unit 12 is installed at a position away from the base point P (installation position of the second optical element 22) to the spectator's seat side by a distance W, such that the display surface of the second display unit 12 is perpendicular to the ground and faces the stage 30 side. In the example illustrated in FIG. 1, the second display unit 12 is installed under the spectator's seat, but the present invention is not limited to this. As the second display unit 12, for example, a display apparatus such as an LED display and an organic EL display can be used. A display image A2 is displayed on the display surface of the second display unit 12. The display image A2 is, for example, an image of the player on the court on the back side of the net 31.

The second optical element 22 is installed to be erected on the ground between the second display unit 12 and the stage 30, and receives light emitted from the second display unit 12. In the example illustrated in FIG. 1, the second optical element 22 is installed at a position of the base point P such that one side of the second optical element 22 is brought into contact with the ground and the second optical element 22 is perpendicular to the ground. In other words, the second optical element 22 is installed so as to be parallel with the display surface at a position away from the second display unit 12 by the distance W. The second optical element 22 is a rectangular or square plate-like optical element, reflects a part of the incident light and transmits a part of the incident light. For example, a half mirror can be used as the second optical element 22.

To prevent total reflection, installation positions of the second display unit 12 and the second optical element 22 are adjusted such that an incident angle of the light incident on the second optical element 22 from the second display unit 12 is equal to or less than the angle θ₀ in which sin θ₀=n₁ (n₁ is a refractive index of the second optical element 22).

Next, the floating image projected by the floating image display apparatus of FIG. 1 will be described.

First, the virtual image B1 formed by the first display unit 11 and the first optical element 21 will be described. When the first display unit 11 displays the display image A1, the light of the display image A1 is directed toward the first optical element 21. The first optical element 21 reflects a part of the light of the display image A1 and emits the light toward the spectator 100. The virtual image B1 is projected at a position away by the same distance D_{F} as the height H from the base point P to the first display unit 11. In the example illustrated in FIG. 1, the height H at which the first display unit 11 is installed is adjusted such that the virtual image B1 is projected on the court on the front side of the net 31. Note that in the example illustrated in FIG. 1, the first display unit 11 is installed at the same position as the upper side of the second optical element 22, but the height H at which the first display unit 11 is installed can be determined according to the position at which the virtual image B1 is to be projected.

Next, the virtual image B2 formed by the second display unit 12 and the second optical element 22 will be described. When the second display unit 12 displays the display image A2, the light of the display image A2 is directed toward the second optical element 22. The second optical element 22 reflects a part of the light of the display image A2 and emits the light toward the spectator 100. The virtual image B2 is projected at a position away by the same distance D_{R} as the distance W from the base point P to the second display unit 12. In the example illustrated in FIG. 1, the distance W between the second display unit 12 and the second optical element 22 is adjusted such that the virtual image B2 is projected on the court on the back side of the net 31. Note that in the example of FIG. 1, the first optical element 21 and the second optical element 22 are installed at the same base point P, but the present invention is not limited to this. The second optical element 22 may be installed at a point closer to the spectator's seat than the first optical element 21.

In the example illustrated in FIG. 1, a net 32 having the same shape as that of the net 31 on the stage 30 is installed between the second display unit 12 and the second optical element 22. The net 31 and the net 32 are at the same distance from the second optical element 22. The net 32 blocks a part of the light from the second display unit 12 and the projection is performed such that a part of the virtual image B2 is blocked by the net 31. Accordingly, an occlusion by the net 31 can be reproduced in the floating image.

Next, an upper limit of a viewing zone of the floating image display apparatus in FIG. 1 will be described.

The upper limit V of the viewing zone illustrated in FIG. 1 is represented by the following equations by using the distance D_{R} from the second optical element 22 to the virtual image B2, a distance D_{V} from the second optical element 22 to the spectator 100, the height H of the second optical element 22, and the height h of the second display unit 12.

$$V : {D}_{V} + {D}_{R} = H - h : {D}_{R} \qquad [ Math . 1 ]$$

$$V = \frac{( {D}_{V} + {D}_{R} ) ( H - h )}{{D}_{R}}$$

It is possible to dispose the spectator 100 in a vertical direction as long as his/her position is lower than V+h, where V is the upper limit of the viewing zone. That is, the present floating image display apparatus can be applied to audiovisual environments, in which the spectator's seat is installed in a stepwise shape, such as a stadium and a movie theater.

Note that here, the badminton competition venue is described as an example, but the present invention can also be applied to other sports events and the stage production in theaters and the like, when total reflection conditions and the upper limit of the viewing zone can be satisfied and the first display unit 11, the second display unit 12, the first optical element 21, and the second optical element 22 can be installed.

As described above, the floating image display apparatus according to the present embodiment includes: the first display unit 11 that is installed to have the display surface facing toward a ground; the first optical element 21 that is installed to be inclined with respect to the ground, transmits a part of the light of the display image A1 displayed by the first display unit 11, and reflects a part of the light; the second display unit 12 that is installed to have the display surface perpendicular to the ground; and the second optical element 22 that is installed to be perpendicular to the ground, transmits a part of the light of the display image A2 displayed by the second display unit 12, and reflects a part of the light. Accordingly, the multilayer virtual images B1 and B2 can be made without installing the second optical element 22 on the stage 30.

Floating Image Display Apparatus of Comparative Example

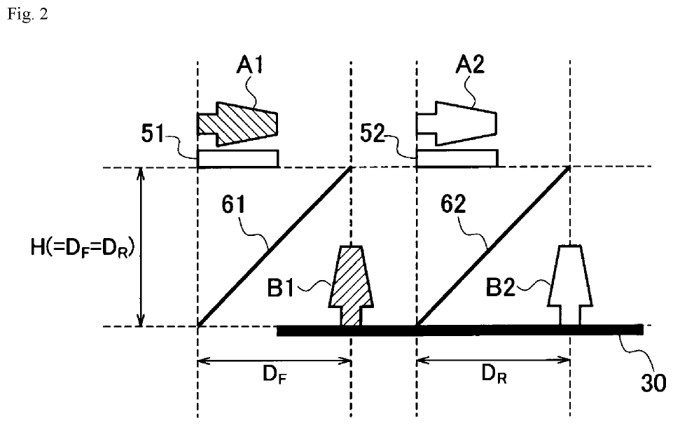

The floating image display apparatus of a comparative example will be described with reference to FIG. 2. The floating image display apparatus illustrated in the drawing is a display apparatus in which a plurality of half mirrors 61 and 62 are installed in parallel with each other and the floating image is projected in multiple layers on the stage 30. The spectator is positioned in a left direction in the drawing of the floating image display apparatus.

A display apparatus 51 is installed such that the display surface of the display apparatus 51 is parallel with the ground and faces downward. The half mirror 61 is installed at a position below the display apparatus 51 and inclined at 45 degrees with respect to the ground, and receives light emitted from the display apparatus 51. When the display apparatus 51 displays the display image A1, the light of the display image A1 is directed toward the half mirror 61. The half mirror 61 reflects a part of the light of the display image A1. The virtual image B1 is made at a position away by the same distance D_{F} as the height H from the ground to the display apparatus 51. The spectator recognizes the virtual image B1 on the stage 30 as a floating image.

A display apparatus 52 is installed on a deeper side of the display apparatus 51 such that the display surface of the display apparatus 52 is parallel with the ground and faces downward. A half mirror 62 is installed at a position below the display apparatus 52 and inclined at 45 degrees with respect to the ground, and receives light emitted from the display apparatus 52. When the display apparatus 52 displays the display image A2, the light of the display image A2 is directed toward the half mirror 62. The half mirror 62 reflects a part of the light of the display image A2. The virtual image B2 is made at a position away by the same distance D_{R} as the height H from the ground to the display apparatus 51. The spectator recognizes the virtual image B2 on the stage 30 as a floating image.

In the floating image display apparatus of the comparative example, a multilayer floating image can be displayed, but the half mirror 62 for displaying the floating image on the deeper side needs to be installed on the stage 30. Therefore, the arrangement of the actual object and the performer on the stage 30 is limited.

Furthermore, since it is assumed to be viewed from a position in a horizontal direction, the floating image display apparatus of the comparative example is not suitable for a configuration in which the spectator is disposed in a vertical direction.

### REFERENCE SIGNS LIST

11 First display unit
12 Second display unit
21 First optical element
22 Second optical element
30 Stage
31, 32 Net

1. A floating image display apparatus comprising:
a first display configured to be installed to have a display surface facing toward a ground;
a first optical element configured to be installed to be inclined with respect to the ground, and configured to transmit a part of light emitted from the first display and reflect a part of the light;
a second display configured to be installed to have a display surface perpendicular to the ground; and
a second optical element configured to be installed to be perpendicular to the ground, and configured to transmit a part of light emitted from the second display and reflect a part of the light.

2. The floating image display apparatus according to claim 1, wherein a view point position is set at a position in a height direction at which the light emitted from the second display is not totally reflected by the second optical element.

3. The floating image display apparatus according to claim 2, wherein the view point position is set above the second display, and the second display is disposed below the view point position.

4. The floating image display apparatus according to claim 1, further comprising:
a first real object installed between the second optical element and a virtual image made by the second optical element; and
a second real object that is installed between the second optical element and the second display and that has a shape identical to a shape of the first real object.

5. The floating image display apparatus according to claim 1, wherein the first optical element and the second optical element are installed at a same position on the ground.

6. A floating image display method comprising:
displaying a first image by a first display installed to have a display surface facing toward a ground;
emitting light of the first image to a first optical element that is installed to be inclined with respect to the ground, that transmits a part of incident light, and that reflects a part of the incident light;
displaying a second image by a second display installed to have a display surface perpendicular to the ground; and
emitting light of the second image to a second optical element that is installed to be perpendicular to the ground, that transmits a part of incident light, and that reflects a part of the incident light.

7. The floating image display method according to claim 6, wherein a view point position is set at a position in a height direction at which the light emitted from the second display is not totally reflected by the second optical element.

8. The floating image display method according to claim 7, wherein the view point position is set above the second display, and the second display is disposed below the view point position.

9. The floating image display method according to claim 6, wherein the first optical element and the second optical element are installed at a same position on the ground.

10. A non-transitory computer recording medium storing a floating image display program, wherein execution of the floating image display program causes one or more computers to perform operations comprising:
displaying a first image by a first display installed to have a display surface facing toward a ground;
emitting light of the first image to a first optical element that is installed to be inclined with respect to the ground, that transmits a part of incident light, and that reflects a part of the incident light;
displaying a second image by a second display installed to have a display surface perpendicular to the ground; and
emitting light of the second image to a second optical element that is installed to be perpendicular to the ground, that transmits a part of incident light, and that reflects a part of the incident light.

11. The non-transitory computer recording medium according to claim 10, wherein a view point position is set at a position in a height direction at which the light emitted from the second display is not totally reflected by the second optical element.

12. The non-transitory computer recording medium according to claim 11, wherein the view point position is set above the second display, and the second display is disposed below the view point position.

13. The non-transitory computer recording medium according to claim 10, wherein the first optical element and the second optical element are installed at a same position on the ground.
